(19) United States
(12) Patent Application Publication
(10) Pub. No.: US 2023/0144474 A1
(43) Pub. Date: May 11, 2023

(54) SYSTEM AND METHOD FOR REMOVING RESIDUAL REDUCTANT

(71) Applicant: Caterpillar Inc., Peoria, IL (US)

(72) Inventors: Andrew Michael Denis, Normal, IL (US); Shawn Richard Herold, East Peoria, IL (US)

(73) Assignee: Caterpillar Inc., Peoria, IL (US)

(21) Appl. No.: 17/454,288

(22) Filed: Nov. 10, 2021

(51) Int. Cl. F01N 3/20; B08B 9/035

(52) U.S. Cl. CPC F01N 3/2066; B08B 9/035; F01N 2610/1493; F01N 2610/1433; F01N 2610/02

(57) ABSTRACT

A system for removing residual reductant from at least one component of a reductant dosing system associated with an aftertreatment system includes a first container disposed in fluid communication with the reductant dosing system. The system also includes a first conduit for providing fluid communication between the first container and the reductant dosing system. Based on a generation of a vacuum within the first container, the first conduit is operative to remove the residual reductant from the at least one component of the reductant dosing system and introduce the residual reductant into the first container.

### TECHNICAL FIELD

The present disclosure relates to an aftertreatment system and a reductant dosing system associated with the aftertreatment system. More particularly, the present disclosure relates to a system and a method for removing residual reductant from one or more components of the reductant dosing system.

### BACKGROUND

Exhaust gases exiting an engine system may contain high concentrations of particulate matter, such as, oxides of nitrogen, carbon monoxide, ammonia, and the like. In order to comply with emission regulation standards, the engine system includes an aftertreatment system. The aftertreatment system may remove and/or control the particulate matter that may be present in the exhaust gases, prior to the exhaust gases exiting into atmosphere.

Aftertreatment systems typically include a diesel oxidation catalyst and a selective catalytic reduction (SCR) device. Before the exhaust gases enter the SCR module, a reductant, such as diesel exhaust fluid, may be dosed into the exhaust gases. The reductant is typically dosed by a reductant dosing system. In air assisted reductant dosing systems, an injector receives a supply of air and the reductant. The injector serves to direct a predetermined spray pattern of the air and the reductant towards the exhaust gases. Further, a pump may be used to direct a pressurized flow of the reductant towards the injector. Moreover, a manifold may receive air from an air supply source and the reductant from the pump. When the aftertreatment system is not in use, a removal of residual reductant may be desirable as the reductant is susceptible to freezing in cold temperatures which may damage one or more components of the of the aftertreatment system.

A primary purging circuit may be associated with the aftertreatment system to purge the reductant from various portions of the aftertreatment system. However, in some cases, the reductant may not completely purge after engine shut-down. For example, some components of the reductant dosing system, such as, the manifold, the pump, and/or pump valves (for e.g., check valves) associated with the pump may not fully purge post a purging process performed by the primary purging circuit. In some examples, purging of the pump valves may be difficult as the pump valves limit flow in one direction.

Further, if the components are not purged completely, residual reductant present in the components of the reductant dosing system may freeze when the engine system is put into long term storage. The freezing of the reductant may damage the components of the reductant dosing system thereby increasing maintenance and/or replacement costs. In some examples, the residual reductant may freeze and crack pump hardware/manifolds.

CN213088097U describes a novel anti-freezing SCR system comprises a urea box, a urea liquid supply pump, an SCR module body, a filter, a urea injector and a sweeping pump, the module body comprises a liquid outlet channel and a liquid return channel, the urea liquid supply pump comprises a liquid supply injector, the urea injector comprises a liquid inlet injector and a liquid return injector, and the liquid inlet injector is communicated with the liquid return channel. The liquid supply injector is connected with one end of a liquid outlet channel of the SCR module body through a liquid supply pipe, the other end of the liquid outlet channel is connected to a liquid inlet injector of the urea injector through a high-pressure pipe to form a urea solution supply flow channel, and a liquid return injector of the urea injector is connected to one end of a liquid return channel of the SCR module body through a liquid return pipe. and the other end of the liquid return channel is connected with the interior of the urea box to form a urea liquid return flow channel. And the cleaning pump sucks gas in the upper space of the urea box, blows the gas into the urea solution supply flow channel, returns to the urea box through the urea solution backflow channel, and brings out the residual urea solution in the pipeline.

### SUMMARY OF THE DISCLOSURE

In one aspect of the present disclosure, a system for removing residual reductant from at least one component of a reductant dosing system associated with an aftertreatment system is provided. The system includes a first container disposed in fluid communication with the reductant dosing system. The system also includes a first conduit for providing the fluid communication between the first container and the reductant dosing system. Based on a generation of a vacuum within the first container, the first conduit is operative to remove the residual reductant from the at least one component of the reductant dosing system and introduce the residual reductant into the first container.

In another aspect of the present disclosure, a method for removing residual reductant from at least one component of a reductant dosing system associated with an aftertreatment system is provided. The method includes providing fluid communication between a first container and the reductant dosing system. A first conduit provides the fluid communication between the first container and the reductant dosing system. The method also includes generating a vacuum within the first container. The method further includes removing the residual reductant from the at least one component of the reductant dosing system based on the generation of the vacuum within the first container. The method includes introducing, by the first conduit, the residual reductant into the first container.

Other features and aspects of this disclosure will be apparent from the following description and the accompanying drawings.

### BRIEF DESCRIPTION OF THE DRAWINGS

FIG. 1 illustrates a schematic view of an engine system and an aftertreatment system associated with the engine system, according to examples of the present disclosure;

FIG. 2 illustrates a cross-sectional view of a pump of a reductant dosing system associated with the aftertreatment system of FIG. 1, according to examples of the present disclosure;

FIG. 3 illustrates a schematic diagram illustrating a system for removing residual reductant from one or more components of the reductant dosing system, according to examples of the present disclosure;

FIG. 4 illustrates a schematic diagram illustrating the system for removing the residual reductant from the one or more components of the reductant dosing system, according to another example of the present disclosure; and

FIG. 5 illustrates a flowchart for a method for removing the residual reductant from the one or more components of the reductant dosing system, according to examples of the present disclosure.

### DETAILED DESCRIPTION

Wherever possible, the same reference numbers will be used throughout the drawings to refer to the same or like parts. Wherever possible, corresponding or similar reference numbers will be used throughout the drawings to refer to the same or corresponding parts.

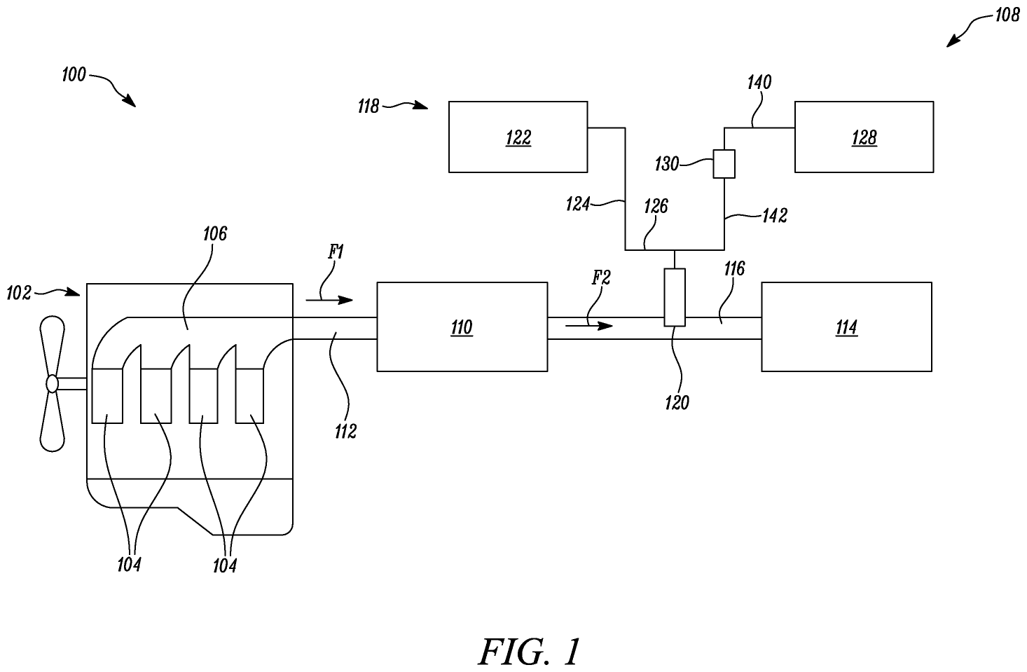

FIG. 1 illustrates a schematic view of an engine system 100, according to an embodiment of the present disclosure. The engine system 100 may be used in a variety of machines (not shown) including, but not limited to, mobile machines (such as, construction machines), stationary machines, and like. The engine system 100 includes an engine 102. The engine 102 may be any type of engine (internal combustion, gas, diesel, gaseous fuel, natural gas, propane, etc.), may be of any size, with any number of cylinders, any type of combustion chamber (cylindrical, rotary spark ignition, compression ignition, 4-stroke and 2-stroke, etc.), and in any configuration (“V,” in-line, radial, etc.).

The engine 102 may include a number of components (not shown) such as a crankshaft, a fuel system, an inlet manifold, an intake port, an exhaust port, and the like. Further, the engine 102 may include a number of cylinders 104 that define one or more combustion chambers (not shown). Moreover, exhaust gases generated based on combustion of fuels in the combustion chambers may be directed towards an exhaust manifold 106 of the engine 102. The exhaust manifold 106 may be in fluid communication with the cylinders 104. It should be noted that the exhaust gases exiting the engine 102 may include particulate matter, such as, carbon monoxide (CO), ammonia, and Oxides of Nitrogen (NOx), such as, Nitric Oxide (NO), Nitrous Oxide (N₂O), and Nitrogen Dioxide (NO₂).

The engine system 100 may include an aftertreatment system 108 for treatment of the exhaust gases exiting the engine 102. The aftertreatment system 108 may operate to reduce/eliminate a concentration of the particulate matter in the exhaust gases, before the exhaust gases are let into the atmosphere. The aftertreatment system 108 may be in fluid communication with the exhaust manifold 106 of the engine 102. The exhaust gases may flow through the aftertreatment system 108 along an exhaust gas flow path “F1”. Further, the aftertreatment system 108 may include various components (not shown), such as, a particulate filter for reducing a content of particulate matter in the exhaust gases, an Ammonia Slip Catalyst (ASC), and the like.

The aftertreatment system 108 may include a first module 110 in fluid communication with the exhaust manifold 106 and positioned downstream of the engine 102 in the exhaust gas flow path “F1”. As illustrated in FIG. 1, the first module 110 may be in fluid communication with the exhaust manifold 106 via a first exhaust conduit 112. The first module 110 may include a diesel oxidation catalyst. In some examples, the first module 110 may include a diesel oxidation catalyst as well as a diesel particulate filter. Alternatively, the first module 110 may include any other suitable exhaust treatment device. The first module 110 may include a canister and one or more catalysts disposed within the canister. The exhaust gases exiting the engine 102 may contain some amount of ammonia present therein. The first module 110 may receive the exhaust gases exiting the engine 102 for oxidizing the ammonia present in the exhaust gases into NOx. In some examples, the first module 110 may oxidize NO to convert NO into NO₂, thereby, changing a ratio of NO:NO₂ within the exhaust gases.

The aftertreatment system 108 may also include a second module 114 in fluid communication with the first module 110 and positioned downstream of the engine 102 in the exhaust gas flow path “F1”. The second module 114 may be in fluid communication with the first module 110 via a second exhaust conduit 116. The second module 114 may embody a selective reductant catalyst (SCR) device. Alternatively, the second module 114 may include any other suitable exhaust treatment device. The second module 114 may include a canister and one or more catalysts disposed within the canister for facilitating reaction, reduction, and removal of NOx from the exhaust gases passing therethrough. The second module 114 may convert NOx into nitrogen (N₂) and water (H₂O).

In some examples, the aftertreatment system 108 may include one or more sensors (not shown) for determining a quantity of particulate matter present in the exhaust gases flowing through the aftertreatment system 108. In an example, the one or more sensors may include a NOx sensor. In some examples, the aftertreatment system 108 may include a first sensor disposed between the exhaust manifold 106 and the first module 110. The aftertreatment system 108 may also include a second sensor disposed between the first module 110 and the second module 114. The aftertreatment system 108 may further include a third sensor disposed at an exit of the second module 114.

The aftertreatment system 108 also includes a reductant dosing system 118 for dosing a reductant in the exhaust gases exiting the first module 110. The reductant may include a diesel exhaust fluid. The reductant may contain a urea based solution, without any limitations. It should be noted that the reductant may include any other type of fluid that is dosed into the exhaust gases, known to a person having ordinary skill in the art. In the illustrated example of FIG. 1, the reductant dosing system 118 includes an air-assisted reductant dosing system.

The reductant dosing system 118 includes an injector 120 for dosing a mixture of the reductant and air into a stream of exhaust gases “F2”. Specifically, the injector 120 may dose the mixture of the reductant and air into the stream of exhaust gases “F2” exiting the first module 110. The injector 120 may be disposed downstream of the first module 110 and may project inside the second exhaust conduit 116. The injector 120 may spray the mixture of the reductant and air based on a predefined spray pattern. In some examples, the injector 120 may combine the reductant with air to produce an atomized spray, which may be introduced into the stream of exhaust gases “F2”.

In various examples, the reductant dosing system 118 may include a single injector or multiple injectors. In the illustrated example of FIG. 1, the reductant dosing system 118 includes the single injector 120. It should be noted that an amount of air and the reductant dosed into the stream of exhaust gases “F2” may be varied based on an amount of the particulate matter present in the stream of exhaust gases “F2”. In an example, the injector 120 may be controlled to vary the amount of air and the reductant that is dosed into the stream of exhaust gases “F2”.

The reductant dosing system 118 includes an air supply device 122. The air supply device 122 may be in fluid communication with the injector 120, via an air supply conduit 124 and a manifold 126. The air supply device 122 may compress air and direct the compressed air towards the injector 120, via the air supply conduit 124 and the manifold 126. In some examples, the air supply device 122 may include a compressor, without any limitations. It should be noted that the present disclosure is not limited by a type of the air supply device 122. Further, the reductant dosing system 118 may include additional components (not shown herein) for directing the air towards the injector 120.

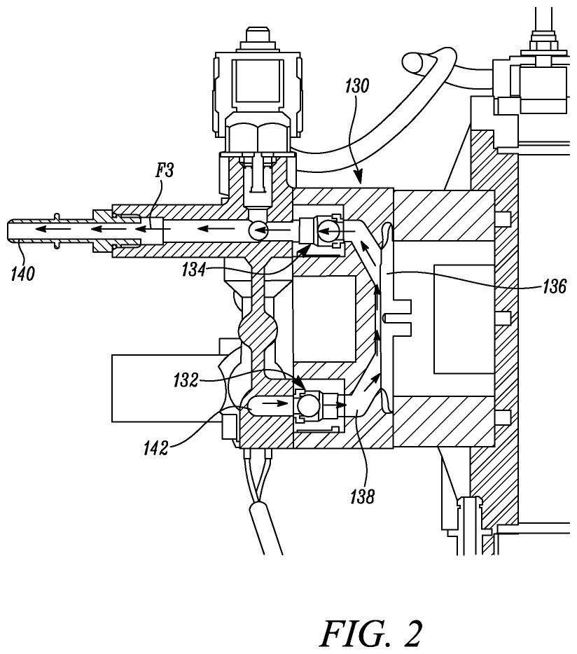

The reductant dosing system 118 also includes a reservoir 128. The reservoir 128 may store the reductant therein and may supply the reductant towards the injector 120, as and when desired. The reductant dosing system 118 includes a pump 130 for directing the reductant towards the manifold 126. The pump 130 may be in fluid communication with the reservoir 128 for receiving the reductant from the reservoir 128. A first reductant supply conduit 140 may provide the fluid communication between the reservoir 128 and the pump 130. The pump 130 may pressurize the reductant and direct the pressurized reductant towards the injector 120. As shown in FIG. 2, the pump 130 may include a first pump valve 132 that may be disposed between the reservoir 128 and the pump 130. Moreover, the pump 130 may include a second pump valve 134 that may be disposed between the pump 130 and the injector 120. In some examples, the first and second pump valves 132, 134 may embody unidirectional valves. In various examples, the first and second pump valves 132, 134 may embody check valves, butterfly valves, flap valves, or any other form of valves, without any limitations.

In the illustrated example of FIG. 2, the pump 130 is embodied as a diaphragm-type pump. Accordingly, the pump 130 may include a diaphragm 136. Alternatively, the pump 130 may embody any other type of pump known in the art, without any limitations. The pump 130 may include a pump chamber 138. The reductant may be introduced in the pump chamber 138 through the first pump valve 132. Further, the reductant may exit the pump chamber 138 via the second pump valve 134. Moreover, a second reductant supply conduit 142 may establish a fluid communication between the pump 130 and the manifold 126. A flow path “F3” defined by the pump 130 for passage of the reductant is illustrated in FIG. 2.

The reductant dosing system 118 may further include the manifold 126 for directing the mixture of reductant and air towards the injector 120. The manifold 126 may be in fluid communication with the air supply device 122 via the air supply conduit 124 for receiving air from the air supply device 122. Further, the manifold 126 may be in fluid communication with the pump 130 via the second reductant supply conduit 142 for receiving the reductant from the pump 130. The manifold 126 may further direct the air and the reductant towards the injector 120.

Further, the reductant dosing system 118 may be purged after a shut-down of the engine system 100 to remove the reductant from various components of the reductant dosing system 118. Thus, the aftertreatment system 108 may include a primary purging system (not shown) generally known in the art that may purge the reductant from injector 120. However, the primary purging system may not effectively remove the reductant present in the manifold 126, the pump 130, and/or the first and second pump valves 132, 134. If the engine system 100 is non-operational for a prolong period of time, the reductant present in the manifold 126, the pump 130, and/or the first and second pump valves 132, 134 may freeze, which may not be desirable.

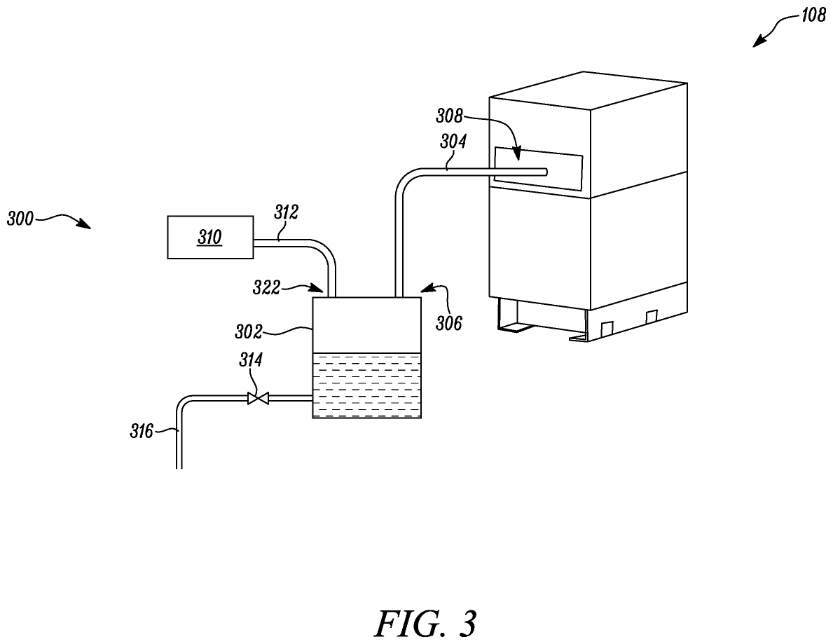

Referring to FIG. 3, the present disclosure relates to a system 300 for removing residual reductant from one or more components of the reductant dosing system 118. In some examples, the one or more components may include the pump 130, the one or more pump valves 132, 134 associated with the pump 130, and/or the manifold 126. In some examples, the system 300 may also remove the residual reductant from the pump chamber 138 and/or the first and second reductant supply conduits 140, 142. The system 300 includes a first container 302 disposed in fluid communication with the reductant dosing system 118. The first container 302 may include any shape, size, or material, as per application requirements. In some examples, the first container 302 may include a bucket.

Further, the system 300 includes a first conduit 304 for providing the fluid communication between the first container 302 and the reductant dosing system 118. The first conduit 304 may include any shape, size, or material, as per application requirements. In some examples, the first conduit 304 may embody a flexible hose, without any limitations. The first conduit 304 may include a first end 306 and a second end 308. The first end 306 of the first conduit may be in fluid communication with the first container 302 and the second end 308 of the first conduit 304 may be in fluid communication with the reductant dosing system 118. In some examples, the second end 308 of the first conduit 304 may connect to a port (not shown) defined in the second reductant supply conduit 142 that connects the pump 130 to the injector 120.

Further, based on a generation of a vacuum within the first container 302, the first conduit 304 removes the residual reductant from the one or more components of the reductant dosing system 118 and introduces the residual reductant into the first container 302. According to one example of the present disclosure, the system 300 may include a vacuum pump 310. The vacuum pump 310 may embody a positive displacement type of vacuum pump, a momentum transfer type of vacuum pump, or a regenerative type of vacuum pump. It should be noted that a type of the vacuum pump 310 does not limit the scope of the present disclosure. In some examples, the vacuum pump 310 may be replaced by a hand-operated pump, without any limitations.

In an example, the vacuum may be generated within the first container 302 based on an activation of the vacuum pump 310. The vacuum pump 310 may be in communication with the first container 302 via a conduit 312. Based on the activation of the vacuum pump 310, the vacuum may be generated within the first container 302 which may in turn draw the residual reductant from the manifold 126, the first and second pump valves 132, 134, the pump chamber 138, the first and second reductant supply conduits 140, 142, and/or other components of the pump 130, via the first conduit 304.

Specifically, based on the generation of the vacuum in the first container 302, a suction force may be generated within the first conduit 304, and the first and second reductant supply conduit 140, 142 along the flow path “F3” (see FIG. 1), which may draw the residual reductant from various components of the reductant dosing system 118 into the first container 302. Further, the residual reductant may be removed from the one or more pump valves 132, 134 on account of an opening of the one or more pump valves 132, 134 due to the vacuum generated in the first container 302. Specifically, the one or more pump valves 132, 134 may open based on the suction force generated within the first conduit 304 and the first and second reductant supply conduit 140, 142 due to the vacuum generated in the first container 302.

In some examples, the first container 302 may contain fluid therein. In an example, the first container 302 may contain water therein. The residual reductant removed from the components of the reductant dosing system 118 may be diluted with the fluid in the first container 302 before disposal.

According to a second example of the present disclosure, the system 300 may include a valve 314 disposed in fluid communication with the first container 302. The valve 314 may be disposed along a conduit 316 such that the valve 314 may be in fluid communication with the first container 302. The valve 314 may be operated to switch the valve 314 between an open position and a closed position. The valve 314 may embody an electrically operated valve, a hydraulically operated valve, and the like, without any limitations. The valve 314 may include a gate valve (or multiturn valve), a check valve, and the like. The valve 314 may include a hand-operated valve or a foot-operated valve. In some examples, the valve 314 may be switched between the open and closed positions by a service personnel. It should be noted that the valve 314 may include any type of valve generally known in the art, without any limitations.

According to the second example of the present disclosure, the vacuum may be generated within the first container 302 based on a draining of the fluid from the first container 302. More specifically, the valve 314 may be operated to switch the valve 314 to the open position. Based on an opening of the valve 314, a portion of the fluid may drain from the first container 302, via the conduit 316. The draining of the fluid may generate the vacuum within the first container 302 which may in turn draw the residual reductant from the manifold 126, the first and second pump valves 132, 134, the pump chamber 138, the first and second reductant supply conduits 140, 142, and/or other components of the pump 130, via the first conduit 304. Further, the residual reductant removed from the components of the reductant dosing system 118 may be diluted with the fluid in the first container 302 before disposal.

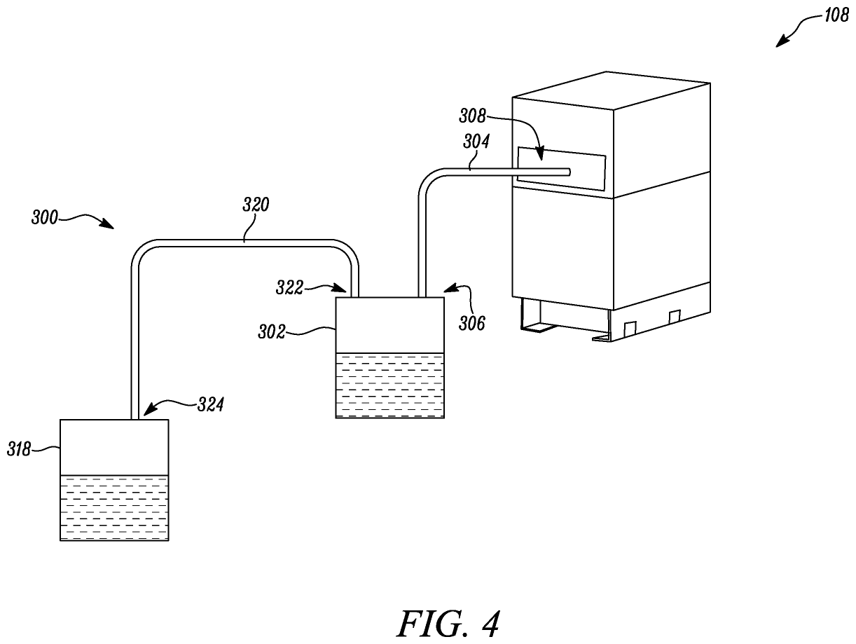

FIG. 4 illustrates a third example of the present disclosure. According to the third example, the vacuum may be generated within the first container 302 based on the draining of the fluid from the first container 302 by siphoning. Further, the system 300 may include a second container 318 in fluid communication with the first container 302. The second container 318 may include any shape, size, or material, as per application requirements. In some examples, the second container 318 may include a bucket.

The system 300 may also include a second conduit 320 for providing the fluid communication between the first container 302 and the second container 318. The second conduit 320 may include any shape, size, or material, as per application requirements. As illustrated in FIG. 4, the second conduit 320 may include an inverted U-shaped design, without any limitations. In some examples, the second conduit 320 may embody a flexible hose, without any limitations. The second conduit 320 may include a third end 322 and a fourth end 324. The third end 322 of the first conduit 304 may be in fluid communication with the first container 302 and the fourth end 324 of the second conduit 320 may be in fluid communication with the second container 318.

In the illustrated example of FIG. 4, the vacuum may be generated within the first container 302 based on directing, via the second conduit 320, the portion of the fluid from the first container 302 towards the second container 318. Further, based on the draining of the fluid from the first container 302 by siphoning, the vacuum may be generated within the first container 302 which in turn draws the residual reductant from the manifold 126, the first and second pump valves 132, 134, the pump chamber 138, the first and second reductant supply conduits 140, 142, and/or other components of the pump 130, via the first conduit 304. Further, the residual reductant removed from the components of the reductant dosing system 118 may be diluted with the fluid in the first container 302 before disposal.

### INDUSTRIAL APPLICABILITY

The present disclosure relates to the system 300 and a method 500 for removing the residual reductant from one or more components of the reductant dosing system 118. In an example, the system 300 may remove the residual reductant from the manifold 126, the first and second pump valves 132, 134, the pump chamber 138, the first and second reductant supply conduits 140, 142, and/or other components of the pump 130. Specifically, the system 300 described herein may be embodied as a secondary purging circuit. The system 300 may remove the residual reductant from various components of the reductant dosing system 118 that may not fully purge using the primary purge circuit associated with the aftertreatment system 108. In some examples, the system 300 may be operated after the shut-down of the engine system 100 for purging of the various components of the reductant dosing system 118. Further, the system 300 may allow purging of the unidirectional pump valves 132, 134 as air from the first container 302 may fill the void left by the residual reductant.

The system 300 and the method 500 described herein may reduce a possibility of failure of the components of the reductant dosing system 118 under freezing conditions when the engine system 100 has not been operated for a prolonged period of time. Further, the system 300 and the method 500 may reduce a possibility of any other failure due to retention of the residual reductant within the components of the reductant dosing system 118 after the shut-down of the engine system 100. The system 300 described herein may provide a cost-effective technique for removing the residual reductant from the components of the reductant dosing system 118. Further, the system 300 described herein may be easy to operate and may allow quick removal of the residual reductant from the components of the reductant dosing system 118.

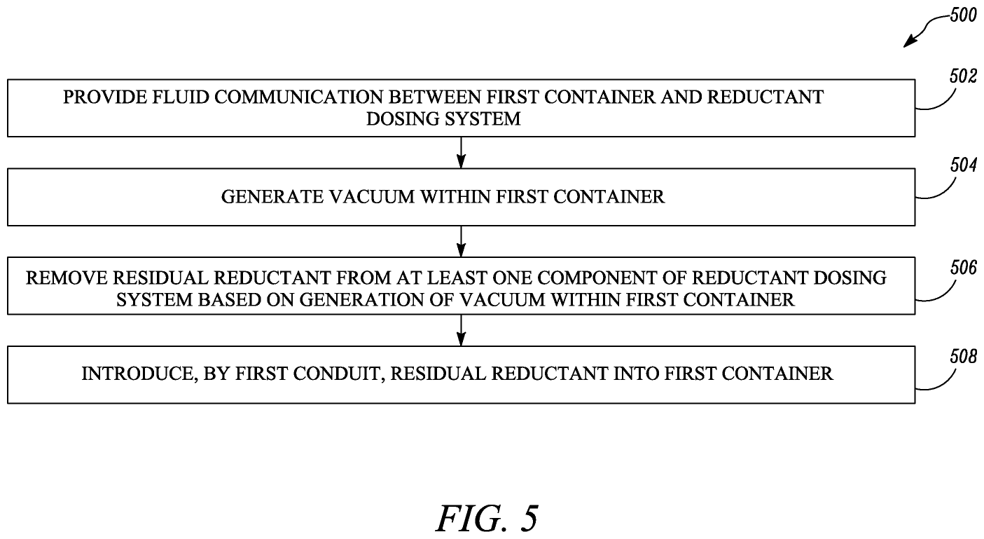

FIG. 5 illustrates a flowchart for the method 500 for removing the residual reductant from one or more components of the reductant dosing system 118 associated with the aftertreatment system 108. The reductant dosing system 118 includes the air-assisted dosing system. The reductant dosing system 118 includes the injector 120 for dosing the mixture of the reductant and air into the stream of exhaust gases “F2”. The reductant dosing system 118 also includes the manifold 126 for directing the mixture of the reductant and air towards the injector 120. The reductant dosing system 118 further includes the pump 130 for directing the reductant towards the manifold 126. Further, the one or more components may include the pump 130, the one or more pump valves 132, 134 associated with the pump 130, and/or the manifold 126.

At step 502, the fluid communication is provided between the first container 302 and the reductant dosing system 118. The first conduit 304 provides the fluid communication between the first container 302 and the reductant dosing system 118. Further, the first end 306 of the first conduit 304 is disposed in fluid communication with the first container 302 and the second end 308 of the first conduit 304 is disposed in fluid communication with the reductant dosing system 118

At step 504, the vacuum is generated within the first container 302. In one example, the vacuum may be generated within the first container 302 based on the activation of the vacuum pump 310. Further, the first container 302 may contain the fluid therein. In another example, the vacuum may be generated within the first container 302 based on the draining of the fluid from the first container 302, wherein the fluid may be drained based on the operation of the valve 314 disposed in fluid communication with the first container 302.

In yet another example, the vacuum may be generated within the first container 302 based on the draining of the fluid from the first container 302 by siphoning. In such an example, the fluid communication may be provided between the first container 302 and the second container 318. The second conduit 320 may provide the fluid communication between the first container 302 and the second container 318. Further, the portion of the fluid may be directed, via the second conduit 320, from the first container 302 towards the second container 318 for generating the vacuum within the first container 302.

At step 506, the residual reductant is removed from the one or more components of the reductant dosing system 118 based on the generation of the vacuum within the first container 302. At step 508, the residual reductant is introduced into the first container 302 by the first conduit 304. Further, in some examples, the residual reductant may be diluted with water before disposal.

It may be desirable to perform one or more of the steps shown in FIG. 5 in an order different from that depicted. Furthermore, various steps could be performed together.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

1. A system for removing residual reductant from at least one component of a reductant dosing system associated with an aftertreatment system, the system comprising:
a first container disposed in fluid communication with the reductant dosing system; and
a first conduit for providing the fluid communication between the first container and the reductant dosing system,
wherein, based on a generation of a vacuum within the first container, the first conduit is operative to remove the residual reductant from the at least one component of the reductant dosing system and introduce the residual reductant into the first container.

2. The system of claim 1 further comprising a vacuum pump, wherein the vacuum is generated within the first container based on an activation of the vacuum pump.

3. The system of claim 1, wherein the first container contains fluid therein.

4. The system of claim 3, wherein the vacuum is generated within the first container based on a draining of the fluid from the first container.

5. The system of claim 4, wherein the fluid is drained from the first container based on an operation of a valve disposed in fluid communication with the first container.

6. The system of claim 4, wherein the vacuum is generated within the first container based on the draining of the fluid from the first container by siphoning.

7. The system of claim 6 further comprising:
a second container in fluid communication with the first container; and
a second conduit for providing the fluid communication between the first container and the second container, wherein the vacuum is generated within the first container based on directing, via the second conduit, a portion of the fluid from the first container towards the second container.

8. The system of claim 1, wherein the reductant dosing system includes an air-assisted dosing system, the reductant dosing system including:
an injector for dosing a mixture of reductant and air into a stream of exhaust gases;
a manifold for directing the mixture of reductant and air towards the injector; and
a pump for directing reductant towards the manifold.

9. The system of claim 8, wherein the at least one component includes at least one of the pump, one or more pump valves associated with the pump, and the manifold.

10. The system of claim 9, wherein the residual reductant is removed from the one or more pump valves on account of an opening of the one or more pump valves due to the vacuum generated in the first container.

11. The system of claim 1, wherein a first end of the first conduit is in fluid communication with the first container and a second end of the first conduit is in fluid communication with the reductant dosing system.

12. A method for removing residual reductant from at least one component of a reductant dosing system associated with an aftertreatment system, the method comprising:
providing a fluid communication between a first container and the reductant dosing system, wherein a first conduit provides the fluid communication between the first container and the reductant dosing system;
generating a vacuum within the first container;
removing the residual reductant from the at least one component of the reductant dosing system based on the generation of the vacuum within the first container; and
introducing, by the first conduit, the residual reductant into the first container.

13. The method of claim 12 further comprising generating the vacuum within the first container based on an activation of a vacuum pump.

14. The method of claim 12, wherein the first container contains fluid therein.

15. The method of claim 14 further comprising generating the vacuum within the first container based on a draining of the fluid from the first container, wherein the fluid is drained based on an operation of a valve disposed in fluid communication with the first container.

16. The method of claim 15 further comprising generating the vacuum within the first container based on the draining of the fluid from the first container by siphoning.

17. The method of claim 16 further comprising:
providing a fluid communication between the first container and a second container, wherein a second conduit provides the fluid communication between the first container and the second container; and
directing, via the second conduit, a portion of the fluid from the first container towards the second container for generating the vacuum within the first container.

18. The method of claim 12, wherein the reductant dosing system includes an air-assisted dosing system, the reductant dosing system including:
an injector for dosing a mixture of reductant and air into a stream of exhaust gases;
a manifold for directing the mixture of reductant and air towards the injector; and
a pump for directing reductant towards the manifold.

19. The method of claim 18, wherein the at least one component includes at least one of the pump, one or more pump valves associated with the pump, and the manifold.

20. The method of claim 12 further comprising disposing a first end of the first conduit in fluid communication with the first container and a second end of the first conduit in fluid communication with the reductant dosing system.
